(19) United States
(12) Patent Application Publication
(10) Pub. No.: US 2024/0280371 A1
(43) Pub. Date: Aug. 22, 2024

(54) INFORMATION PROCESSING DEVICE, INFORMATION PROCESSING METHOD, AND RECORDING MEDIUM

(71) Applicant: Panasonic Intellectual Property Management Co., Ltd., Osaka (JP)

(72) Inventors: Ryo OTSUKI, Nara Ken (JP); Koji SATO, Osaka Fu (JP); Masayuki FUKUYAMA, Osaka Fu (JP); Hirofumi NISHIMURA, Kanagawa Ken (JP); Yoshimasa OKABE, Kanagawa Ken (JP)

(73) Assignee: Panasonic Intellectual Property Management Co., Ltd., Osaka (JP)

(21) Appl. No.: 18/416,604

(22) Filed: Jan. 18, 2024

(30) Foreign Application Priority Data
Feb. 22, 2023 (JP) 2023- 026322

(51) Int. Cl. G01C 21/36

(52) U.S. Cl. CPC G01C 21/3632

(57) ABSTRACT

An information processing device includes a specifier, a guide screen generator, and an output controller. The specifier specifies an autonomous traveling startable point on a teaching path. The teaching path extends from a predetermined position to a target position in a real space. The guide screen generator generates a guide screen for guiding a moving body to the autonomous traveling startable point. The output controller outputs the guide screen before start of autonomous traveling.

### CROSS-REFERENCE TO RELATED APPLICATIONS

This application is based upon and claims the benefit of priority from Japanese Patent Application No. 2023-026322, filed on Feb. 22, 2023, the entire contents of which are incorporated herein by reference.

### FIELD

Embodiments described herein relate generally to an information processing device, an information processing method, and a recording medium.

### BACKGROUND

A technique has been disclosed (for example, JP 2022-136584 A), in which a traveling path of a moving body is stored as a teaching path to cause the moving body to autonomously travel on the basis of the teaching path.

In addition, a technique has been disclosed (for example, JP 2021-124301 A), in which a moving body itself is localized by collating a feature point extracted from an image of the periphery of the moving body with a feature point included in map data, and the moving body is caused to autonomously travel along a teaching path.

However, in the related art, there is a case where, when autonomous traveling is started at a location where the number of the features of the environment around the moving body is small, the self-localization cannot be done, autonomous traveling along the teaching path is difficult.

### SUMMARY

An information processing device according to the present disclosure includes a specifier, a guide screen generator, and an output controller. The specifier specifies an autonomous traveling startable point on a teaching path. The teaching path extends from a predetermined position to a target position in a real space. The guide screen generator generates a guide screen for guiding a moving body to the autonomous traveling startable point. The output controller outputs the guide screen before start of autonomous traveling.

An information processing method according to the present disclosure includes: specifying an autonomous traveling startable point on a teaching path, the teaching path extending from a predetermined position to a target position in a real space; generating a guide screen for guiding a moving body to the autonomous traveling startable point; and outputting the guide screen before start of autonomous traveling.

### BRIEF DESCRIPTION OF THE DRAWINGS

FIG. 1 is a diagram illustrating an example of a moving body according to an embodiment;

FIG. 2 is a schematic view illustrating an example of installation positions of image capturing devices;

FIG. 3 is an example of a hardware configuration diagram of an information processing device;

FIG. 4 is a block diagram illustrating an example of a functional configuration of the moving body;

FIG. 5 is an explanatory diagram of an example of specifying an autonomous traveling startable point;

FIG. 6A is a schematic diagram of an example of a guide screen;

FIG. 6B is a schematic diagram of an example of a guide screen;

FIG. 7A is a schematic diagram of an example of a positional relationship between a teaching path and the moving body;

FIG. 7B is a schematic diagram of an example of a guide screen;

FIG. 8A is a schematic diagram of an example of a positional relationship between the teaching path and the moving body;

FIG. 8B is an explanatory diagram of an example of a guide screen;

FIG. 9 is a flowchart illustrating an example of a procedure of information processing executed in a teaching traveling mode; and

FIG. 10 is a flowchart illustrating an example of a procedure of information processing executed after teaching traveling processing.

### DETAILED DESCRIPTION

Embodiments of an information processing device, an information processing method, and a recording medium according to the present disclosure will be described with reference to the accompanying drawings.

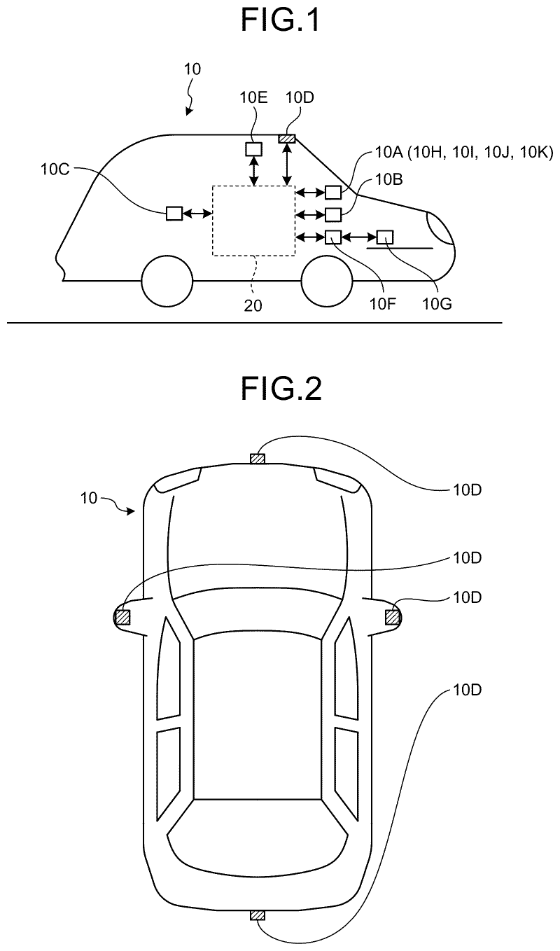

FIG. 1 is a diagram illustrating an example of a moving body 10 according to the present embodiment.

The moving body 10 includes an information processing device 20, an output unit 10A, an input unit 10B, an internal sensor 10C, image capturing devices 10D, a drive controller 10F, and a driving unit 10G.

The information processing device 20 is, for example, a dedicated or general-purpose computer. In the present embodiment, a mode in which the information processing device 20 is mounted on the moving body 10 will be described as an example.

The moving body 10 is a movable object. In the present embodiment, the moving body 10 is an object that a user can get in. The moving body 10 is, for example, a vehicle. The vehicle is a two-wheeled vehicle, a three-wheeled vehicle, a four-wheeled vehicle, or the like. Moreover, the moving body 10 is, for example, a moving body that travels by means of a driving operation by a person or a moving body that can autonomously travel (self-driving) without a driving operation by a person. In the present embodiment, a case where the moving body 10 is a vehicle capable of autonomous traveling will be described as an example.

The output unit 10A outputs information. In the present embodiment, the output unit 10A outputs information generated in the information processing device 20. Details of the output information will be described below.

The output unit 10A has a display function to display information. Note that the output unit 10A may further have a communication function to transmit information to an external device or the like, a sound output function to output sound, a function to continuously emit or blink light, and the like. For example, the output unit 10A includes a display unit 10K, and at least one of a communication unit 10H, a loudspeaker 10I, and an illumination unit 10J. In the present embodiment, a case where the output unit 10A includes the communication unit 10H, the loudspeaker 10I, the illumination unit 10J, and the display unit 10K will be described as an example.

The communication unit 10H transmits information to another device. For example, the communication unit 10H transmits information to another device via a known communication line. The loudspeaker 10I outputs sound. The illumination unit 10J is a light that continuously emits or blinks light. The display unit 10K displays information. The display unit 10K is, for example, a known organic electro luminescence (EL) display, a liquid crystal display, or a projection device.

The installation position of the output unit 10A may be any position as long as the user riding in the moving body 10 can confirm the information output from the output unit 10A. For example, as for the display unit 10K, the direction of the display surface is adjusted in advance in order that the user riding in the moving body 10 can visually recognize the display surface.

The input unit 10B receives an input of an instruction or information from the user. The input unit 10B is, for example, at least one of an instruction input device that receives an input by means of a user's operation and a microphone that receives a voice input. The instruction input device is, for example, a button, a pointing device such as a mouse and a trackball, or a keyboard. The instruction input device may be an input function on a touch panel provided integrally with the display unit 10K.

The internal sensor 10C is a sensor that observes information of the moving body 10 itself. The internal sensor 10C detects the position of the moving body 10, the speed of the moving body 10, the acceleration of the moving body 10, or the like.

The internal sensor 10C is, for example, an inertial measurement unit (IMU), a speed sensor, or a global positioning system (GPS).

The image capturing devices 10D are each a sensor that observes the periphery of the moving body 10. The image capturing device 10D may be mounted on the moving body 10 or may be mounted outside the moving body 10. The outside of the moving body 10 indicates, for example, another moving body or an external device.

The periphery of the moving body 10 is a region within a predetermined range from the moving body 10. This range is an observable range for the image capturing device 10D. This range may be set in advance.

The image capturing device 10D observes the periphery of the moving body 10 and acquires peripheral information. The peripheral information includes at least one of an image of the periphery of the moving body 10 and information indicating a distance and a direction between an object at the periphery of the moving body 10 and the moving body 10.

The image capturing device 10D acquires captured image data (hereinafter referred to as a captured image) by means of image capturing. The image capturing device is a digital camera, a stereo camera, or the like. The captured image is digital image data in which a pixel value is defined for each pixel.

In the present embodiment, a case where the peripheral information acquired by the image capturing device 10D is a captured image of the periphery of the moving body 10 will be described as an example. Hereinafter, a captured image of the periphery of the moving body 10 will be referred to as a peripheral image.

The installation position and the angle of view of each of the image capturing devices 10D are adjusted in advance so that the image of the periphery of the moving body 10 can be captured. In the present embodiment, the image capturing devices 10D installed in the moving body 10 are different in image capturing direction.

FIG. 2 is a schematic view illustrating an example of installation positions of the image capturing devices 10D. For example, the moving body 10 includes four image capturing devices 10D. Note that the number of image capturing devices 10D provided in the moving body 10 is not limited to four. For example, the installation positions and the number of the image capturing devices 10D may be adjusted in order that a captured image substantially in all directions (for example, 360°) centering on the moving body 10 on the horizontal plane can be captured.

Returning to FIG. 1, the description will be continued. The driving unit 10G is a drive device mounted on the moving body 10. The driving unit 10G is, for example, an engine, a motor, a wheel, or the like.

The drive controller 10F controls the driving unit 10G. The driving unit 10G is driven under the control of the drive controller 10F. For example, in order to autonomously operate the moving body 10, the drive controller 10F controls the driving unit 10G on the basis of information obtained from the internal sensor 10C or the image capturing device 10D, information received from the information processing device 20, or the like. The accelerator amount, the brake amount, the steering angle, and the like of the moving body 10 are controlled under the control of the driving unit 10G. For example, the drive controller 10F controls the moving body 10 to enter a space indicated by the information received from the information processing device 20, and to stop or travel.

Next, a hardware configuration of the information processing device 20 will be described.

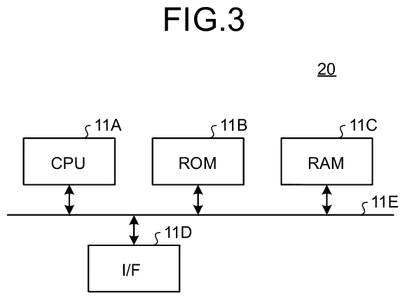

FIG. 3 is an example of a hardware configuration diagram of the information processing device 20.

The information processing device 20 has a hardware configuration as in a normal computer that a central processing unit (CPU) 11A, a read only memory (ROM) 11B, a random access memory (RAM) 11C, an I/F 11D, and the like are connected to one another by a bus 11E.

The CPU 11A is an arithmetic device that controls the information processing device 20 of the present embodiment. The ROM 11B stores a program or the like that enables the CPU 11A to execute processing. The RAM 11C stores data that the CPU 11A requires to execute processing. The I/F 11D is an interface for data transmission and reception.

A computer program for executing information processing executed by the information processing device 20 of the present embodiment is embedded in the ROM 11B or the like in advance and provided. Note that the program executed by the information processing device 20 of the present embodiment may be configured to be stored and provided in a computer-readable storage medium (for example, a flash memory) as a file in a format installable in or executable by the information processing device 20.

Next, a functional configuration of the moving body 10 will be described.

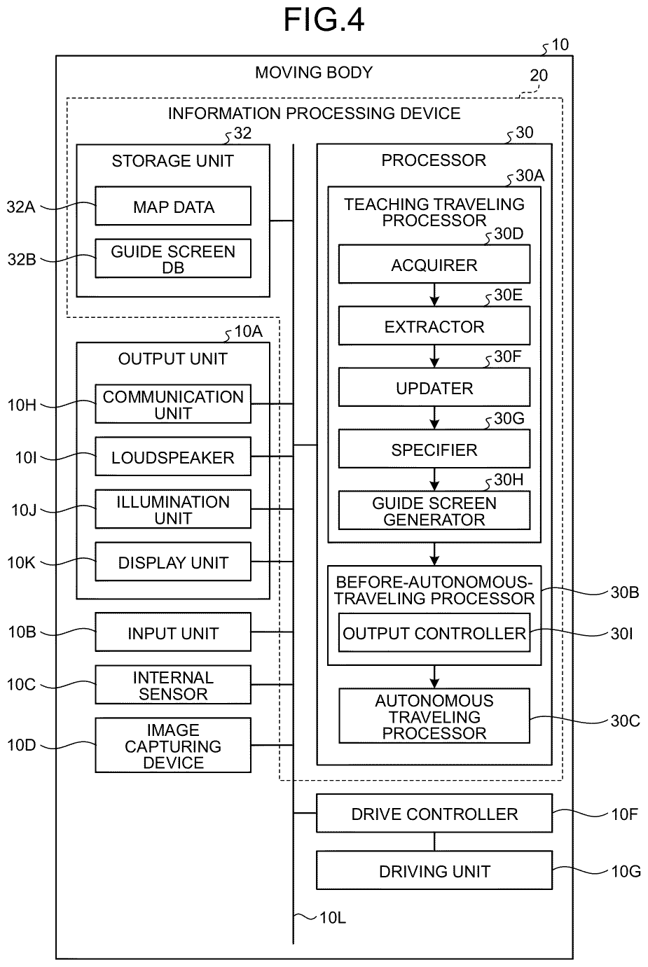

FIG. 4 is a block diagram illustrating an example of a functional configuration of the moving body 10.

The moving body 10 includes an information processing device 20, an output unit 10A, an input unit 10B, an internal sensor 10C, an image capturing device 10D, a drive controller 10F, and a driving unit 10G.

The information processing device 20, the output unit 10A, the input unit 10B, the internal sensor 10C, the image capturing device 10D, and the drive controller 10F are connected via a bus 10L or the like so as to be able to transmit and receive data or signals. The drive controller 10F is connected to the driving unit 10G so as to be able to transmit and receive data or signals.

The information processing device 20 includes a storage unit 32 and a processor 30. The processor 30 and the storage unit 32 are connected via the bus 10L or the like so as to be able to transmit and receive data or signals. Moreover, the output unit 10A, the input unit 10B, the internal sensor 10C, the image capturing device 10D, and the drive controller 10F are connected to the processor 30 via the bus 10L or the like so as to be able to transmit and receive data or signals.

Note that at least one of the storage unit 32, the output unit 10A (the communication unit 10H, the loudspeaker 10I, the illumination unit 10J, and the display unit 10K), the input unit 10B, the internal sensor 10C, the image capturing device 10D, and the drive controller 10F has only to be connected to the processor 30 in a wired or wireless manner. Moreover, at least one of the storage unit 32, the output unit 10A (the communication unit 10H, the loudspeaker 10I, the illumination unit 10J, and the display unit 10K), the input unit 10B, the internal sensor 10C, the image capturing device 10D, and the drive controller 10F may be connected to the processor 30 via a network.

The storage unit 32 stores data. The storage unit 32 is, for example, a random access memory (RAM), a semiconductor memory element such as a flash memory, a hard disk, or an optical disk. Note that the storage unit 32 may be a storage device provided outside the information processing device 20. Moreover, the storage unit 32 may store or temporarily store a program or information downloaded via a local area network (LAN), the Internet, or the like. Moreover, the storage unit 32 may include a plurality of storage media.

In the present embodiment, the storage unit 32 stores map data 32A, a guide screen DB (database) 32B, and the like. Details of the map data 32A and the guide screen DB 32B will be described below.

The processor 30 executes information processing in the information processing device 20. The processor 30 includes a teaching traveling processor 30A, a before-autonomous-traveling processor 30B, and an autonomous traveling processor 30C. The teaching traveling processor 30A includes an acquirer 30D, an extractor 30E, an updater 30F, a specifier 30G, and a guide screen generator 30H. The before-autonomous-traveling processor 30B includes an output controller 30I.

The teaching traveling processor 30A, the before-autonomous-traveling processor 30B, the autonomous traveling processor 30C, the acquirer 30D, the extractor 30E, the updater 30F, the specifier 30G, the guide screen generator 30H, and the output controller 30I are operated by, for example, one or more processors. For example, each of the above units may be operated by causing a processor such as a CPU to execute a computer program, namely, operated by software. Each of the above units may be operated by a processor such as a dedicated integrated circuit (IC), namely, operated by hardware. Each of the above units may be operated by using software and hardware in combination. In a case where multiple processors are used, each of those processors may operate one of the units, or may operate two or more of the units.

The processor reads and executes the program stored in the storage unit 32 to operate the units. Instead of storing the program in the storage unit 32, the program may be directly embedded in the circuit of the processor. In this case, the processor reads and executes the program embedded in the circuit to operate the units.

The teaching traveling processor 30A executes processing in a teaching traveling mode.

The moving body 10 of the present embodiment includes two or more traveling modes. The traveling modes include a teaching traveling mode and an autonomous traveling mode. The teaching traveling mode is a mode in which creation of the map data 32A at the periphery of the moving body 10 and generation of a teaching path are executed by traveling of the moving body 10. The autonomous traveling mode is a mode in which the moving body 10 is caused to autonomously travel along the teaching path.

The teaching traveling processor 30A executes processing in the teaching traveling mode when a teaching traveling start instruction signal to give instructions for start of teaching traveling is input by means of an instruction operation using the input unit 10B or the like by the user.

The teaching traveling processor 30A includes an acquirer 30D, an extractor 30E, an updater 30F, a specifier 30G, and a guide screen generator 30H.

The acquirer 30D acquires peripheral information from the image capturing device 10D. As described above, in the present embodiment, the image capturing device 10D acquires the peripheral image which is a captured image of the periphery of the moving body 10 as the peripheral information. Therefore, the acquirer 30D acquires the peripheral image of the moving body 10 from the image capturing device 10D.

The image capturing device 10D acquires the peripheral image at predetermined times as time goes by. Then, every time the peripheral image is acquired, the image capturing device 10D outputs the acquired peripheral image to the processor 30. Therefore, the acquirer 30D of the teaching traveling processor 30A sequentially acquires peripheral images from the image capturing device 10D.

The extractor 30E analyzes the peripheral image acquired by the acquirer 30D from the image capturing device 10D to extract feature points around the path on which the moving body 10 has traveled.

The feature point is a point that is characteristic in the real space. Specifically, the feature point is part of image information from which a characteristic image pattern can be obtained. The image information represents an object (for example, a building, a sign, or a signboard) that can be a landmark in the real space. Specifically, for example, the feature point is an edge, an end, a corner, a portion where a color difference is equal to or larger than a threshold, or the like of the object, but is not limited thereto.

The extractor 30E extracts a feature point by analyzing the peripheral image by a known analysis method such as edge detection and extracting a feature value for each position included in the peripheral image.

The feature value of the feature point is data that represents the feature of the feature point. Examples of the feature value for the feature point include luminance and concentration of image information, and may also include a scale invariant feature transform (SIFT) feature value or a speeded up robust features (SURF) feature value.

The updater 30F updates the map data 32A on the basis of the extraction result by the extractor 30E. Specifically, the updater 30F registers, for each of the feature points extracted by the extractor 30E, a feature value of the feature point and positional information, which is a three-dimensional position of the feature point in the real space, in the map data 32A in association with each other.

The map data 32A is data in which the three-dimensional positional information of the feature point of the object existing in the real space is registered.

The updater 30F may derive the positional information of the feature point in the real space by using the positional information of the moving body 10 acquired from the internal sensor 10C and the like. For deriving the positional information, the three-dimensional position in the real space may be used.

The positional information of the three-dimensional position of the feature point in the real space, registered in the map data 32A, is represented by, for example, a three-dimensional orthogonal coordinate system (X, Y, and Z) with reference to latitude, longitude, and height. Note that the three-dimensional position of the feature point in the real space may be derived from camera images captured at multiple positions by, for example, measurement based on the principle of triangulation, light detection and ranging (LIDAR), or measurement using a stereo camera.

In addition, the updater 30F may assign an identification number capable of uniquely identifying each feature point to each feature point and register the identification number in the map data 32A.

As a method for creating the map data 32A by means of the updater 30F, a known method may be used, and the creation method is not limited. For example, the updater 30F creates positional information indicating the position of the feature point extracted by the extractor 30E to create the map data 32A having the positional information of the feature point.

In addition, the updater 30F registers a traveling path of the moving body 10 in the teaching traveling mode in the map data 32A as a teaching path. For example, the updater 30F sequentially registers, in the map data 32A as a moving body position, positional information of the moving body 10 that moves as the moving body 10 travels in the teaching traveling mode.

Specifically, for example, after the traveling mode of the moving body 10 is switched to the teaching traveling mode by means of the instruction operation using the input unit 10B or the like by the user, and while the moving body 10 is traveling by means of a driving operation by the user from a predetermined position in the real space that is a point where the moving body 10 starts traveling, to a target position that is a point where the moving body 10 reaches at the end of the teaching traveling, the updater 30F sequentially registers the positional information of the moving body 10 as the moving body position in the map data 32A. With this registration processing, the updater 30F registers, in the map data 32A, the traveling path from the predetermined position in the real space, which is a point where the moving body 10 starts traveling in the teaching traveling, to the target position of the moving body 10 when the teaching traveling is ended, as the teaching path. Note that the updater 30F may store the teaching path in the storage unit 32 separately from the map data 32A.

Next, the specifier 30G will be described. The specifier 30G specifies an autonomous traveling startable point.

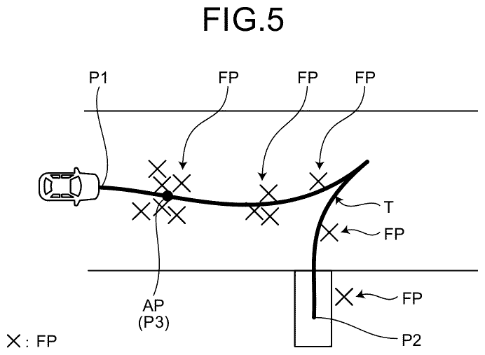

FIG. 5 is an explanatory diagram of an example of specifying an autonomous traveling startable point AP by means of the specifier 30G.

The autonomous traveling startable point AP is a point where the moving body 10 is able to start autonomous traveling. Specifically, the autonomous traveling startable point AP is a point where the moving body 10 is able to start autonomous traveling on a teaching path T extending from a predetermined position P1 to a target position P2 in the real space.

The autonomous traveling startable point is a point where the autonomous traveling can be started. Specifically, the point where the autonomous traveling can be started refers to a point where the number of feature points FP for use in localization of the moving body 10 is equal to or larger than a first threshold. Moreover, the point where the autonomous traveling can be started may be a point on the teaching path T from which the feature point FP suitable for performing self-localization with sufficient accuracy when the moving body 10 starts the autonomous traveling is extracted. The feature point FP is a feature point registered in the map data 32A, and is registered in the map data 32A during the teaching traveling.

Here, at the time of the autonomous traveling, the processor 30 of the moving body 10 extracts a feature point from the peripheral image captured by the image capturing device 10D, and checks which of feature points FP included in the map data 32A matches the extracted feature point. The processor 30 can localize the moving body 10 in a case where the number of the feature points FP matching the map data 32A is equal to or larger than the first threshold which is a predetermined number.

The specifier 30G specifies, as the autonomous traveling startable point AP, a point on the teaching path T where the self-localization can be performed. Specifically, for example, by using the map data 32A, the specifier 30G specifies, as the autonomous traveling startable point AP, a point on the teaching path T from which feature points FP whose number is equal to or larger that the first threshold are extracted.

In one example, the specifier 30G specifies, as the autonomous traveling startable point AP, a point where the number of the feature points FP existing within a predetermined distance range from the teaching path T is equal to or larger than the first threshold. In this case, a value that is equal to or larger than a lower limit number of matching feature points FP, which enables the moving body 10 to be localized, may be set in advance as the first threshold.

This distance range only needs to be a range equal to or smaller than an observable range for the image capturing device 10D, and may be set in advance. This distance range only needs to be, for example, equal to or smaller than a maximum observable range for the image capturing device 10D and equal to or smaller than a maximum range required for accurate self-localization.

It is assumed that the map data 32A provides the distribution of the feature points FP illustrated in FIG. 5. It is also assumed that a point on the teaching path T where the number of the feature points FP is equal to or larger than the first threshold is a point P3. In this case, the specifier 30G specifies the point P3 on the teaching path T as the autonomous traveling startable point AP.

Also, the specifier 30G may specify, as the autonomous traveling startable point AP, a point from which feature points FP whose number is equal to or larger than the first threshold are extracted, the point being located on a linear path having a predetermined or longer length on the teaching path T. The predetermined length of the linear path may be set in advance. The predetermined length of the linear path only needs to be a length that enables the moving body 10 located at the point to start traveling in a posture along the teaching path T. Specifically, for example, the predetermined length of the linear path may be M times or longer the entire length of the moving body 10. The value M may be one or more.

In addition, the specifier 30G may specify the autonomous traveling startable point AP such that a section where the number of the feature points FP is equal to or lower than a second threshold is not included in a section from the autonomous traveling startable point AP on the teaching path T to the target position P2 on the teaching path T.

As the second threshold, a value less than the first threshold, which is the lower limit number of the feature points FP necessary for self-localization, may be set in advance. Specifically, as the second threshold, a value which is low for the number of the feature points FP necessary for self-localization and which is an upper limit making it difficult for the processor 30 of the moving body 10 to localize the moving body 10 even with use of the dead reckoning (DR) technique may be set in advance.

In addition, the specifier 30G may specify, as the autonomous traveling startable point AP, a point on the teaching path T from which the feature point FP suitable for performing self-localization with sufficient accuracy when the moving body 10 starts the autonomous traveling is extracted.

Then, the specifier 30G registers the specified autonomous traveling startable point AP in the map data 32A in association with the positional information of the autonomous traveling startable point AP in the real space.

Returning to FIG. 4, the description will be continued.

The guide screen generator 30H generates a guide screen for guiding the moving body 10 to the autonomous traveling startable point AP.

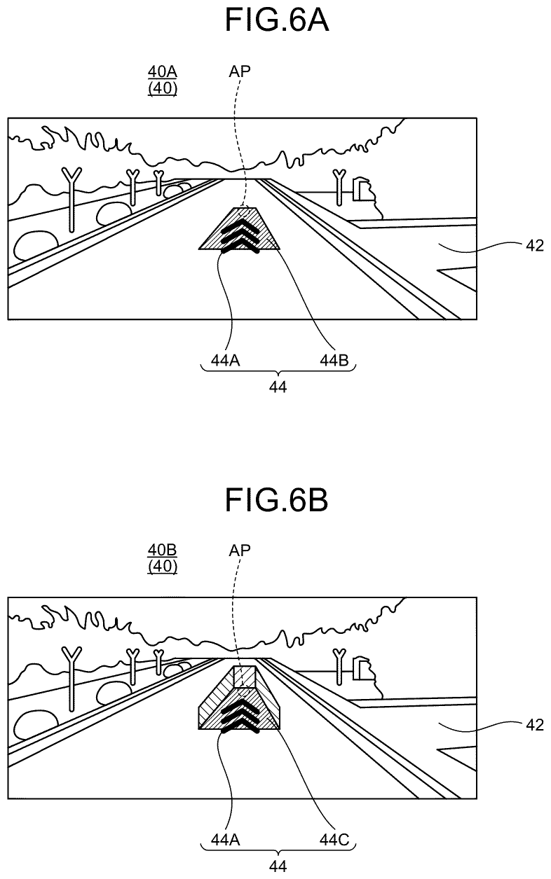

FIGS. 6A and 6B are schematic diagrams of examples of guide screens 40.

FIG. 6A is a schematic diagram of an example of a guide screen 40A. The guide screen 40A is an example of the guide screen 40.

The guide screen generator 30H generates, as the guide screen 40A, a superimposed image obtained by superimposing a graphic image 44 representing a traveling direction to the autonomous traveling startable point AP on the autonomous traveling startable point AP specified by the specifier 30G on a peripheral image 42 including the autonomous traveling startable point AP captured during the teaching traveling.

The graphic image 44 may be any image representing a traveling direction to the autonomous traveling startable point AP. For example, the graphic image 44 may be an image including an arrow representing the traveling direction to the autonomous traveling startable point AP. FIG. 6A illustrates, as an example, a mode in which the graphic image 44 includes an arrow image 44A representing the traveling direction to the autonomous traveling startable point AP.

Moreover, the graphic image 44 may be an image representing the traveling direction to the autonomous traveling startable point AP and a recommended posture of the moving body 10 when the moving body 10 is located at the autonomous traveling startable point AP.

The recommended posture of the moving body 10 refers to a posture in which the moving body 10 can travel along the teaching path T from the autonomous traveling startable point AP when located at the autonomous traveling startable point AP. The recommended posture of the moving body 10 is expressed by the body inclination or the like of the moving body 10 with respect to each of the traveling direction of the moving body 10 and the vehicle width direction orthogonal to the traveling direction and the height direction (vertical direction).

The guide screen generator 30H may generate the guide screen 40A by superimposing the graphic image 44 including a posture image 44B representing the recommended posture on the peripheral image 42 such that the moving body 10 takes the recommended posture when located at the autonomous traveling startable point AP.

FIG. 6A illustrates, as an example, a mode in which the graphic image 44 includes the arrow image 44A representing the traveling direction to the autonomous traveling startable point AP and the posture image 44B representing the posture of the moving body 10 when the moving body 10 is located at the autonomous traveling startable point AP. FIG. 6A illustrates an example in which a rectangular icon image obtained by schematizing in a two-dimensional shape the moving body 10 when located at the autonomous traveling startable point AP in a posture of being able to travel along the teaching path T is set as the posture image 44B.

Note that the posture image 44B is not limited to a rectangular icon image along the two-dimensional plane. FIG. 6B is a schematic diagram of an example of a guide screen 40B. The guide screen 40B is an example of the guide screen 40. As illustrated in FIG. 6B, for example, a posture image 44C may be an icon image obtained by schematizing in a three-dimensional shape the moving body 10 when located at the autonomous traveling startable point AP in a posture of being able to travel along the teaching path T.

In addition, the guide screen generator 30H may generate, as the guide screen 40, a superimposed image in which another graphic image 44 having a shape of converging along the teaching path T toward the autonomous traveling startable point AP is superimposed on the autonomous traveling startable point AP in the peripheral image 42.

Specifically, for example, as illustrated in FIGS. 6A and 6B, the guide screen generator 30H may use, as the posture image 44B and the posture image 44C representing the posture of the moving body 10 when the moving body 10 is located at the autonomous traveling startable point AP, a rectangular icon image whose width narrows along the teaching path T toward the autonomous traveling startable point AP so as to have a shape of converging toward the autonomous traveling startable point AP. In addition, the guide screen generator 30H may form the arrow image 44A having a shape in which the width thereof narrows along the teaching path T toward the autonomous traveling startable point AP. By forming the graphic image 44 having a shape of converging along the teaching path T toward the autonomous traveling startable point AP, the user who drives the moving body 10 can easily adjust the moving body 10 to have a posture matching the recommended posture by adjusting the posture of the moving body 10 to the graphic image 44.

The size of the graphic image 44 to be superimposed on the peripheral image 42 is not limited. For example, the guide screen generator 30H may generate, as the guide screen 40, a superimposed image in which the graphic image 44 is superimposed on an area including the autonomous traveling startable point AP on the teaching path T and one or more points outside the teaching path T, the one or more points being points where the feature points FP around the autonomous traveling startable point AP, whose number is equal or larger than the first threshold, are extracted.

Returning to FIG. 4, the description will be continued.

The guide screen generator 30H registers the generated guide screen 40 in the guide screen DB 32B in association with the positional information, in the real space, of the autonomous traveling startable point AP used to generate the guide screen 40. The guide screen DB 32B is a database in which the positional information in the real space and the guide screen 40 are associated with each other. Note that the data format of the guide screen DB 32B is not limited to the database. Note that the guide screen generator 30H may register the generated guide screen 40 in the map data 32A in association with the positional information, in the real space, of the autonomous traveling startable point AP used to generate the guide screen 40.

Next, the before-autonomous-traveling processor 30B will be described. The before-autonomous-traveling processor 30B executes processing when the traveling mode of the moving body 10 is a traveling mode other than the teaching traveling mode and the autonomous traveling mode. Specifically, the before-autonomous-traveling processor 30B executes processing after the map data 32A and the guide screen 40 are generated in the teaching traveling mode and before the traveling mode is switched to the autonomous traveling mode.

The before-autonomous-traveling processor 30B includes an output controller 30I.

The output controller 30I outputs the guide screen 40 before the start of the autonomous traveling. The output controller 30I outputs the guide screen 40 to the display unit 10K.

For example, the output controller 30I outputs the guide screen 40 to the display unit 10K when the position of the moving body 10 that is traveling becomes a position within a predetermined distance from the autonomous traveling startable point AP registered in the map data 32A. When the position of the moving body 10 acquired from the internal sensor 10C becomes a position within a predetermined distance from a position indicated by the positional information of the autonomous traveling startable point AP registered in the map data 32A, the output controller 30I outputs the guide screen 40 for guiding to the autonomous traveling startable point AP to the display unit 10K. The predetermined distance may be set in advance. Moreover, the predetermined distance may appropriately be changeable by means of the instruction operation using the input unit 10B or the like by the user.

In addition, the output controller 30I may output the guide screen 40 to the display unit 10K when an instruction signal indicating preparation for starting the autonomous traveling is input by means of the instruction operation using the input unit 10B or the like by the user.

By executing the processing, the output controller 30I outputs the guide screen 40 to the display unit 10K before the start of the autonomous traveling. Therefore, the output controller 30I can provide the user of the moving body 10 with information prompting the moving body 10 to travel toward the autonomous traveling startable point AP. By checking the guide screen 40 output to the display unit 10K, the user who drives the moving body 10 can cause the moving body 10 to travel toward the autonomous traveling startable point AP.

In addition, when the moving body 10 travels and approaches the autonomous traveling startable point AP displayed on the guide screen 40 and the self-localization of the moving body 10 using the feature point FP is successful, the output controller 30I displays the guide screen 40 on which an icon image indicating the current position of the moving body 10 is superimposed.

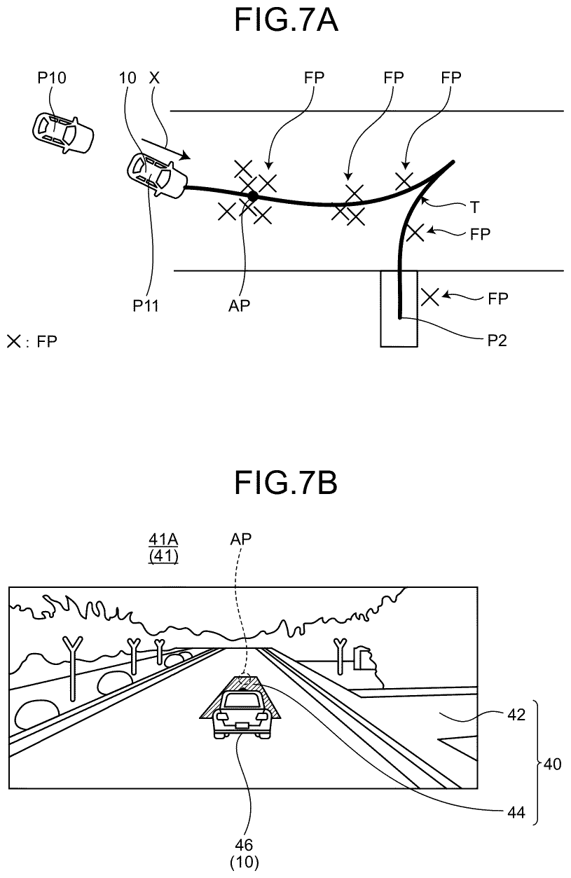

FIGS. 7A and 7B are explanatory diagrams of an example of output of a guide screen 41 by the output controller 30I.

FIG. 7A is a schematic diagram of an example of a positional relationship between the teaching path T and the moving body 10. For example, when the moving body 10 is located at a point P10 away from the autonomous traveling startable point AP by a predetermined distance or more, the output controller 30I outputs the guide screen 40 for guiding to the autonomous traveling startable point AP to the display unit 10K. For example, the output controller 30I outputs the guide screen 40 (40A and 40B) illustrated in FIG. 6A or 6B to the display unit 10K. Then, a scene is assumed in which the moving body 10 moves in a traveling direction X and reaches a point P11 within a predetermined distance from the autonomous traveling startable point AP. Then, a scene is assumed in which the processor 30 of the moving body 10 has successfully performed the self-localization using the feature point FP. In this case, the output controller 30I outputs the guide screen 41 to the display unit 10K.

FIG. 7B is a schematic diagram illustrating an example of a guide screen 41A displayed on the display unit 10K by the output controller 30I. The guide screen 41A is an example of the guide screen 41. The guide screen 41 is a guide screen displayed on the display unit 10K by the output controller 30I using the guide screen 40 generated by the guide screen generator 30H.

When the moving body 10 travels and approaches the autonomous traveling startable point AP displayed on the guide screen 40 and the self-localization using the feature point FP registered in the map data 32A is successful, the output controller 30I outputs to the display unit 10K the guide screen 41A obtained by superimposing an icon image 46 indicating the current position of the moving body 10 onto the guide screen 40. The icon image 46 indicating the current position of the moving body 10 may be superimposed and displayed in a non-transparent or semi-transparent manner.

Therefore, the output controller 30I can provide the user with information indicating that the moving body approaches the autonomous traveling startable point AP and is ready for the self-localization when the moving body approaches the autonomous traveling startable point AP and is ready for the self-localization. By checking the guide screen 41A output to the display unit 10K, the user who drives the moving body 10 can easily confirm that the moving body 10 has approached the autonomous traveling startable point AP and is ready for the self-localization.

Then, when the moving body 10 reaches the autonomous traveling startable point AP, the output controller 30I further superimposes and displays, on the guide screen 40, the teaching path T or a path image representing a recommended path for causing the moving body 10 to join the teaching path T according to the current position and posture of the moving body 10. That is, the output controller 30I displays, on the display unit 10K, the guide screen 41 in which the teaching path T or the path image representing the recommended path is further superimposed on the guide screen 40.

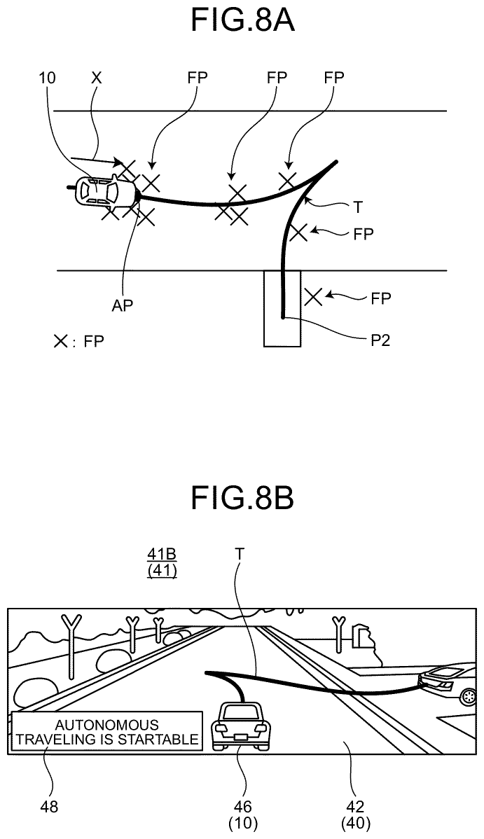

FIGS. 8A and 8B are explanatory diagrams of an example of output of a guide screen 41B by the output controller 30I. The guide screen 41B is an example of the guide screen 41.

FIG. 8A is a schematic diagram of an example of a positional relationship between the teaching path T and the moving body 10. For example, a scene is assumed in which the moving body 10 reaches the autonomous traveling startable point AP. When the moving body 10 reaches the autonomous traveling startable point AP, as illustrated in FIG. 8B, the output controller 30I displays, on the display unit 10K, the guide screen 41B in which the teaching path T is further superimposed on the guide screen 40. Further, as illustrated in FIG. 8B, the output controller 30I may further superimpose and display a message 48 indicating that the moving body has reached the autonomous traveling startable point AP.

Therefore, when the moving body 10 reaches the autonomous traveling startable point AP, the output controller 30I can provide the user with information indicating that the moving body has reached the autonomous traveling startable point AP and has become ready to start the autonomous traveling along the teaching path T. By checking the guide screen 41B output to the display unit 10K, the user who drives the moving body 10 can easily confirm that the moving body 10 has reached the autonomous traveling startable point AP and is ready to start the autonomous traveling along the teaching path T.

Note that there is a case where the posture of the moving body 10 when reaching the autonomous traveling startable point AP is a posture in which it is difficult to travel along the teaching path T from the autonomous traveling startable point AP. In this case, the output controller 30I acquires from the internal sensor 10C the position and posture of the moving body 10 when reaching the autonomous traveling startable point AP. Then, using the acquired position and posture, the output controller 30I generates a recommended path for causing the moving body 10 having the position and posture to join the teaching path T by traveling. To generate the recommended path, a known method may be used. Then, the output controller 30I may output, to the display unit 10K, the guide screen 41B on which the recommended path is further superimposed instead of or together with the teaching path T.

Returning to FIG. 4, the description will be continued.

The autonomous traveling processor 30C performs the self-localization using the map data 32A and performs the autonomous traveling. Specifically, the autonomous traveling processor 30C extracts a feature point from the peripheral image captured by the image capturing device 10D, and checks which feature point FP included in the map data 32A matches the extracted feature point. The autonomous traveling processor 30C can localize the moving body 10 in a case where the number of the feature points FP matching the map data 32A is equal to or larger than the first threshold. While performing the self-localization, the autonomous traveling processor 30C controls the drive controller 10F in order that the self-position can match the teaching path T. With this control, the autonomous traveling processor 30C controls the drive controller 10F so that the moving body 10 is able to autonomously travel along the teaching path T.

Next, an example of a procedure of information processing executed by the information processing device 20 will be described.

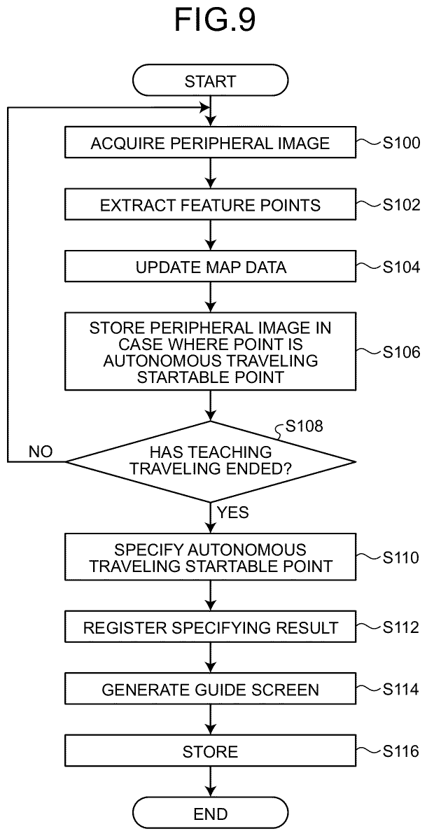

FIG. 9 is a flowchart illustrating an example of a procedure of information processing executed by the information processing device 20 in the teaching traveling mode. When the mode is switched to the teaching traveling mode, the teaching traveling processor 30A of the information processing device 20 executes teaching traveling processing illustrated in FIG. 9.

The acquirer 30D acquires a peripheral image of the moving body 10 from the image capturing device 10D (Step S100).

The extractor 30E analyzes the peripheral image acquired in Step S100 to extract the feature points FP around the path on which the moving body 10 has traveled (Step S102).

The updater 30F updates the map data 32A on the basis of the feature points FP extracted in Step S102 (Step S104). The updater 30F registers, for each of the feature points FP extracted in Step S102, a feature value of the feature point FP and positional information, which is a three-dimensional position of the feature point FP in the real space, in the map data 32A in association with each other. In addition, the updater 30F registers a traveling path of the moving body 10 in the teaching traveling mode in the map data 32A as a teaching path. For example, the updater 30F sequentially registers, in the map data 32A as a moving body position, positional information of the moving body 10 that moves as the moving body 10 travels in the teaching traveling mode. The path provided by movement of the moving body in the teaching traveling mode is registered in the map data 32A as the teaching path T.

In a case where the number of the feature points FP extracted in Step S102 is equal to or larger than the first threshold, the updater 30F stores the peripheral image acquired in Step S100 and the positional information of the moving body 10 at the time of acquiring the peripheral image in the storage unit 32 in association with each other (Step S106). The storage capacity of the storage unit 32 can be saved by storing, in the storage unit 32, the peripheral image whose number of the feature points FP is equal to or larger than the first threshold. Note that the processor 30 may store all the peripheral images acquired in Step S100 in the storage unit 32 in association with the positional information of the moving body 10 at the time of acquiring the peripheral images.

Subsequently, the processor 30 determines whether or not the teaching traveling has ended (Step S108). In one example, when a signal indicating an instruction to end the teaching traveling is input by means of the instruction operation using the input unit 10B or the like by the user, the processor 30 makes determination that the teaching traveling has ended.

In a case where a negative determination is made in Step S108 (Step S108: No), the processing returns to Step S100. In a case where an affirmative determination is made in Step S108 (Step S108: Yes), the processing proceeds to Step S110.

In Step S110, the specifier 30G specifies the autonomous traveling startable point AP on the teaching path T using the map data 32A updated in the processing in Steps S100 to S112 (Step S110).

Then, the specifier 30G registers the specified autonomous traveling startable point AP in the map data 32A in association with the positional information of the autonomous traveling startable point AP in the real space (Step S112).

The guide screen generator 30H generates the guide screen 40 for guiding the moving body 10 to the autonomous traveling startable point AP specified in Step S110 (Step S114).

The guide screen generator 30H registers the generated guide screen 40 in the guide screen DB 32B in association with the positional information, in the real space, of the autonomous traveling startable point AP used to generate the guide screen 40 (Step S116). In addition, the guide screen generator 30H may register the generated guide screen 40 in the map data 32A in association with the positional information, in the real space, of the autonomous traveling startable point AP used to generate the guide screen 40. Then, this routine is ended.

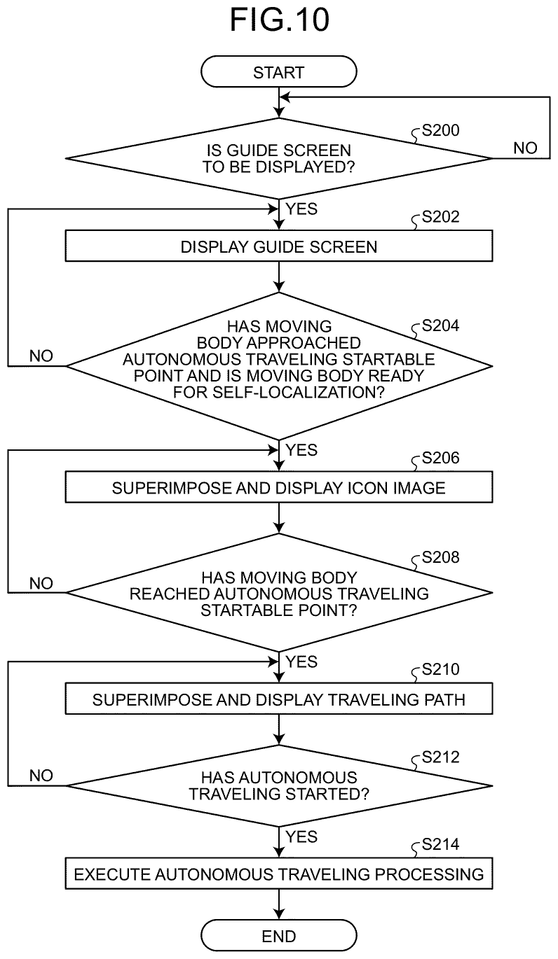

FIG. 10 is a flowchart illustrating an example of a procedure of information processing executed by the information processing device 20 after the teaching traveling processing.

The output controller 30I determines whether or not to display the guide screen 40 (Step S200). The output controller 30I makes the determination in Step S200 by determining whether or not the position of the moving body 10 traveling becomes a position within a predetermined distance from the autonomous traveling startable point AP registered in the map data 32A. The output controller 30I repeats a negative determination (Step S200: No) until an affirmative determination (Step S200: Yes) is made in Step S200. In a case where the affirmative determination is made in Step S200 (Step S200: Yes), the processing proceeds to Step S202.

In Step S202, the output controller 30I outputs the guide screen 40 to the display unit 10K (Step S202). Note that there is a case where plural autonomous traveling startable points AP are registered in the map data 32A. In this case, the output controller 30I may output to the display unit 10K the guide screen 40 including one or more of the plural autonomous traveling startable points AP that are associated with the positional information closest to the current position of the moving body 10.

Subsequently, the output controller 30I determines whether or not the moving body 10 has approached the autonomous traveling startable point AP included in the guide screen 40 displayed in Step S202 and is ready for the self-localization (Step S204). In a case where a negative determination is made in Step S204 (Step S204: No), the processing returns to Step S202. In a case where an affirmative determination is made in Step S204 (Step S204: Yes), the processing proceeds to Step S206.

In Step S206, the output controller 30I outputs to the display unit 10K the guide screen 41A in which the icon image 46 indicating the current position of the moving body 10 is superimposed and displayed on the guide screen 40 displayed in Step S202 (Step S206).

Subsequently, the output controller 30I determines whether or not the moving body 10 has reached the autonomous traveling startable point AP included in the guide screen 40 displayed in Step S202 (Step S208). In a case where a negative determination is made in Step S208 (Step S208: No), the processing returns to Step S206. In a case where an affirmative determination is made in Step S208 (Step S208: Yes), the processing proceeds to Step S210.

In Step S210, the output controller 30I outputs, to the display unit 10K, the guide screen 41 in which the teaching path T is further superimposed on the guide screen 40 displayed in Step S202 or the guide screen 41 displayed in Step S206 (Step S210). In addition, the output controller 30I may further superimpose and display the message 48 indicating that the moving body has reached the autonomous traveling startable point AP, and the output controller 30I may generate and further superimpose and display a recommended path for causing the moving body to join the teaching path T.

Subsequently, the before-autonomous-traveling processor 30B determines whether or not the autonomous traveling is started (Step S212). For example, the before-autonomous-traveling processor 30B makes the determination in Step S212 by determining whether or not an autonomous traveling execution instruction signal to give instructions for execution of the autonomous traveling is input by means of the instruction operation using the input unit 10B or the like by the user. In a case where a negative determination is made in Step S212 (Step S212: No), the processing returns to Step S210. In a case where an affirmative determination is made in Step S212 (Step S212: Yes), the processing proceeds to Step S214.

In Step S214, the autonomous traveling processor 30C executes the autonomous traveling processing (Step S214). The autonomous traveling processor 30C performs the self-localization using the map data 32A and performs the autonomous traveling along the teaching path T. Then, this routine is ended.

As described above, the information processing device 20 according to the present embodiment includes the specifier 30G, the guide screen generator 30H, and the output controller 30I. The specifier 30G specifies the autonomous traveling startable point AP on the teaching path T from the predetermined position P1 to the target position P2 in the real space. The guide screen generator 30H generates the guide screen 40 for guiding the moving body 10 to the autonomous traveling startable point AP. The output controller 30I outputs the guide screen 40 (guide screen 41) before the start of the autonomous traveling.

Incidentally, in the related art, there is a case where, when autonomous traveling is started at a location where the number of the features of the environment around the moving body is small, the self-localization cannot be done, autonomous traveling along the teaching path T is difficult. Specifically, in a case where the driver inputs an autonomous traveling execution instruction at a freely-selected position set as an autonomous driving start position, and where there are few feature points FP for use in self-localization at the position, it may be difficult to start autonomous traveling along the teaching path T.

On the other hand, the information processing device 20 according to the present embodiment outputs the guide screen 40 for guiding the moving body 10 to the autonomous traveling startable point AP on the teaching path T before the start of the autonomous traveling.

Therefore, the information processing device 20 of the present embodiment can provide the user of the moving body 10 before the start of the autonomous traveling with information prompting the moving body 10 to travel toward the autonomous traveling startable point AP, which is a point where the autonomous traveling can be started. By checking the guide screen 40 output to the display unit 10K, the user who drives the moving body 10 can cause the moving body 10 to travel toward the autonomous traveling startable point AP. The moving body 10 starts the autonomous traveling when the moving body reaches the autonomous traveling startable point AP, which means that the moving body 10 can start the autonomous traveling at a position where the self-localization can be performed, and thus the moving body 10 can perform the autonomous traveling along the teaching path T.

Therefore, the information processing device 20 of the present embodiment can assist in the autonomous traveling along the teaching path T.

In addition, the specifier 30G of the information processing device 20 according to the present embodiment may specify, as the autonomous traveling startable point AP, a point on the teaching path T from which feature points FP whose number is equal to or larger than the first threshold are extracted. Therefore, the output controller 30I outputs the guide screen 40 to the autonomous traveling startable point AP to the display unit 10K to enable the moving body to be effectively guided to a point where the self-localization can be performed, that is, a point where the autonomous traveling can be started.

Also, the specifier 30G of the information processing device 20 according to the present embodiment may specify, as the autonomous traveling startable point AP, a point from which feature points FP whose number is equal or larger than the first threshold are extracted, the point being located on a linear path having a predetermined or longer length in the teaching path T.

In a case where the autonomous traveling startable point AP is a point on a curved path, and where the autonomous traveling is started from the point, the autonomous traveling along the teaching path T may be difficult. On the other hand, in the processor 30 of the present embodiment, the specifier 30G specifies, as the autonomous traveling startable point AP, a point from which feature points FP whose number is equal or larger than the first threshold are extracted, the point being located on a linear path having a predetermined or longer length in the teaching path T. Therefore, the information processing device 20 of the present embodiment can provide assistance to facilitate the autonomous traveling along the teaching path T.

In addition, the specifier 30G of the information processing device 20 according to the present embodiment may specify, as the autonomous traveling startable point AP, a point on the teaching path T that does not include a section on the teaching path T where the number of the feature points FP is equal to or lower than the second threshold.

In a case where the moving body 10 autonomously travels along the teaching path T, the self-localization may be difficult at a location where the number of the feature points FP is small. In this case, there is a case where the moving amount and the moving direction are estimated from the feature points FP and the result of the pulse measurement for the wheel of the moving body 10 by means of the dead reckoning technique to perform the self-localization of the moving body 10. However, the accuracy of the dead reckoning technique tends to decrease as the distance increases. For this reason, in a section in the teaching path T where the number of the feature points FP is equal to or lower than the second threshold, the self-localization using the feature points FP and the dead reckoning technique may become difficult, and traveling along the teaching path T may become difficult. On the other hand, the specifier 30G of the information processing device 20 according to the present embodiment specifies, as the autonomous traveling startable point AP, a point on the teaching path T that does not include a section on the teaching path T where the number of the feature points FP is equal to or lower than the second threshold.

Therefore, in the information processing device 20 of the present embodiment, the output controller 30I outputs the guide screen 40 to the autonomous traveling startable point AP to the display unit 10K to enable the moving body to be effectively guided to a point where the self-localization can be performed, that is, a point where the autonomous traveling can be started.

Incidentally, even in a case where the moving body 10 reaches the autonomous traveling startable point AP, which is a point where the self-localization is possible, whereby the moving body 10 is ready for the self-localization, the posture of the moving body 10 with respect to the teaching path T may be greatly different. In a case where the posture of the moving body 10 with respect to the teaching path T is greatly different, in the process of autonomous traveling so as to cause the moving body to join the teaching path T from the autonomous traveling startable point AP, the moving body autonomously travels at a position outside of the teaching path T. Therefore, it may be difficult for the moving body to continuously localize itself with high accuracy during the autonomous traveling.

On the other hand, the guide screen generator 30H of the information processing device 20 according to the present embodiment generates, as the guide screen 40, a superimposed image obtained by superimposing the graphic image 44 representing a traveling direction to the autonomous traveling startable point AP and a recommended posture of the moving body 10 when the moving body 10 is located at the autonomous traveling startable point AP on the autonomous traveling startable point AP on the peripheral image 42 including the autonomous traveling startable point AP.

Therefore, by visually recognizing the guide screen 40, the user can travel toward the autonomous traveling startable point AP while adjusting the posture to match the recommended posture provided by the graphic image 44 when the moving body 10 reaches the autonomous traveling startable point AP. Therefore, in addition to the above effects, the information processing device 20 of the present embodiment can provide assistance in order that the self-localization with respect to the teaching path T can be performed continuously and accurately during the autonomous traveling.

In addition, the guide screen generator 30H generates, as the guide screen 40, a superimposed image in which the graphic image 44 having a shape of converging along the teaching path T toward the autonomous traveling startable point AP is superimposed. Specifically, as described above, the guide screen generator 30H generates, as the guide screen 40, a superimposed image in which the graphic image 44 including a rectangular icon image whose width narrows along the teaching path T toward the autonomous traveling startable point AP is superimposed. Therefore, the user can cause the moving body 10 to travel toward the autonomous traveling startable point AP while adjusting the position and posture of the moving body 10 along the graphic image 44 included in the guide screen 40. Therefore, the information processing device 20 according to the present embodiment can provide assistance such that the posture of the moving body 10 when reaching the autonomous traveling startable point AP is a posture that enables the moving body to autonomously travel along the teaching path T from the autonomous traveling startable point AP.

Note that, in the present embodiment, a mode in which the information processing device 20 is mounted on the moving body 10 has been described as an example. However, the information processing device 20 may be mounted outside the moving body 10. In this case, the information processing device 20 may be able to communicate with each of electronic devices such as the internal sensor 10C mounted on the moving body 10 via a network.

Note that the program for executing the information processing in the above-described embodiment has a module configuration including the above-described respective functional units, and as actual hardware, for example, the CPU (processor circuit) reads and executes the information processing program from the ROM or the HDD, whereby the above-described respective functional units are loaded onto the RAM (main storage), and the above-described respective functional units are generated on the RAM (main storage). Note that some or all of the functional units described above can also be achieved by using dedicated hardware such as an application specific integrated circuit (ASIC) or a field-programmable gate array (FPGA).

While certain embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a specifier that specifies an autonomous traveling startable point on a teaching path, the teaching path extending from a predetermined position to a target position in a real space;
a guide screen generator that generates a guide screen for guiding a moving body to the autonomous traveling startable point; and
an output controller that outputs the guide screen before start of autonomous traveling.

2. The information processing device according to claim 1, wherein the specifier specifies, as the autonomous traveling startable point, a point on the teaching path where self-localization can be performed.

3. The information processing device according to claim 1, wherein the specifier specifies, as the autonomous traveling startable point, a point on the teaching path from which a feature point suitable for performing self-localization with sufficient accuracy for starting the autonomous traveling is extracted.

4. The information processing device according to claim 1, wherein the specifier specifies, as the autonomous traveling startable point, a point on the teaching path from which feature points used for self-localization are extracted, the number of the feature point being equal to or larger than a first threshold.

5. The information processing device according to claim 4, wherein the specifier specifies, as the autonomous traveling startable point, a point from which the feature points whose number is equal to or larger than the first threshold are extracted, the point being located on a linear path having a predetermined or longer length in the teaching path.

6. The information processing device according to claim 4, wherein the specifier specifies the autonomous traveling startable point such that a section where the number of the feature points is equal to or lower than a second threshold is not included in a section from the autonomous traveling startable point on the teaching path to the target position on the teaching path, the second threshold being is less than the first threshold.

7. The information processing device according to claim 1, wherein the guide screen generator generates, as the guide screen, a superimposed image obtained by superimposing a graphic image onto the autonomous traveling startable point included in a peripheral image captured during teaching traveling, the graphic image representing a traveling direction to the autonomous traveling startable point.

8. The information processing device according to claim 1, wherein the guide screen generator generates, as the guide screen, a superimposed image obtained by superimposing a graphic image onto the autonomous traveling startable point included in a peripheral image captured during teaching traveling, the graphic image representing a traveling direction to the autonomous traveling startable point and a recommended posture of the moving body when the moving body is located at the autonomous traveling startable point.

9. The information processing device according to claim 1, wherein the guide screen generator generates, as the guide screen, a superimposed image obtained by superimposing a graphic image onto the autonomous traveling startable point included in a peripheral image captured during teaching traveling, the graphic image having a shape of converging along the teaching path toward the autonomous traveling startable point.

10. The information processing device according to claim 4, wherein the guide screen generator generates, as the guide screen, a superimposed image obtained by superimposing a graphic image representing a traveling direction to the autonomous traveling startable point onto an area including
the autonomous traveling startable point being a point on the teaching path from which the feature points whose number is equal to or larger than the first threshold are extracted, and
one or more points located outside the teaching path, the one or more points being points where the feature points around the autonomous traveling startable point, whose number is equal to or larger than the first threshold, are extracted.

11. The information processing device according to claim 4, wherein, when the moving body travels and approaches the autonomous traveling startable point displayed on the guide screen and the self-localization using the feature point is successful, the output controller displays the guide screen on which an icon image indicating a current position of the moving body is superimposed.

12. The information processing device according to claim 1, wherein, when the moving body reaches the autonomous traveling startable point, the output controller displays the guide screen on which the teaching path or a path image is superimposed, the path image representing a recommended path for causing the moving body to join the teaching path according to a current position and posture.

13. An information processing method comprising:
specifying an autonomous traveling startable point on a teaching path, the teaching path extending from a predetermined position to a target position in a real space;
generating a guide screen for guiding a moving body to the autonomous traveling startable point; and
outputting the guide screen before start of autonomous traveling.

14. A non-transitory computer-readable recording medium on which programmed instructions are recorded, the programmed instructions causing a computer to execute processing, the processing to be executed by the computer comprising:
specifying an autonomous traveling startable point on a teaching path, the teaching path extending from a predetermined position to a target position in a real space;
generating a guide screen for guiding a moving body to the autonomous traveling startable point; and
outputting the guide screen before start of autonomous traveling.
